(19) United States
(12) Patent Application Publication
(10) Pub. No.: US 2005/0129838 A1
(43) Pub. Date: Jun. 16, 2005

(54) Process for the manufacture of electrodes and high energy lithium polymer batteries

(75) Inventors: Herbert Naarmann, Frankenthal (DE); Franz Josef Kruger, Eppstein (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: GAIA Akkumulatorenwerke GmbH, Nordhausen (DE)

(21) Appl. No.: 10/980,221

(22) Filed: Nov. 3, 2004

(30) Foreign Application Priority Data
Apr. 1, 2003 (DE) 103 14 826.4

(51) Int. Cl. B05D 5/12; H01M 4/62; H01M 4/04

(52) U.S. Cl. 427/58; 429/217; 29/623.1

(57) ABSTRACT

Electrodes for high energy lithium polymer batteries are produced. An electrode material mixture of a Li-intercalatable active electrode material, a supporting electrolyte and a solvent is mixed with a binder. Homogenization of the mixture results in a single phase suspension electrode mass which is applied to a conductor to form a homogeneous coating thereon. The electrode mass is adjusted to the desired thickness after drying.

### FIELD OF THE INVENTION

This invention relates to processes for the manufacture of electrodes and high energy lithium polymer batteries.

### BACKGROUND OF THE INVENTION

Lithium polymer batteries with electrodes and separators suitable for high energy applications are well known. Batteries are also known in the case in which the electrodes, i.e. the anode and/or cathode, consist of a conductor and an electrode mass applied to the conductor. To produce the electrode mass, active electrode materials, for example, are embedded in a polymer binder, if necessary with conductivity improving additives.

From document DE-A-199 25 683 it is known that negative electrodes (anodes) can be made by means of a latex additive based on an acrylic acid derivative copolymer and a polymer binder containing butadiene units. In this case, carbon black is homogenized with the latex additive dispersed in a solvent. Graphite is added and stirring is carried out to form a homogeneous mass. A polymer binder, if necessary, is incorporated during the last step.

From DE-A 10 020 031, the manufacture of lithium polymer batteries, free from carrier solvents, is known by extrusion coating.

What is required is a process for the manufacture of electrodes and high energy lithium polymer batteries with improved physical properties and improved service life.

### SUMMARY OF THE INVENTION

The aforementioned objects may be achieved according to the practice of the present invention. According to one embodiment, the invention is a process for the manufacture of electrodes for high energy lithium polymer batteries. The process comprises the following steps: (i) preparing an electrode material mixture by mixing a Li-intercalatable active electrode material, a supporting electrolyte and a solvent; (ii) mixing the electrode material mixture with a binder; (iii) homogenizing the electrode material mixture until the electrode mass is present as a single phase suspension; (iv) applying the active electrode mass as a homogeneous coating onto a conductor; (v) drying the electrode mass applied to the conductor; and (vi) adjusting the electrode mass to a desired layer thickness.

The invention is also directed to the production of high energy lithium polymer batteries comprising electrodes prepared according to the aforementioned process.

### DETAILED DESCRIPTION OF THE INVENTION

In the process of the invention for the manufacture of electrodes for high energy lithium polymer batteries, intercalatable active electrode materials, supporting electrolytes, solvents and optional battery-specific additives are mixed to form an electrode material mixture. A binder is added to the mixture and thoroughly admixed therewith. The mixture is homogenized until a single phase suspension is obtained. The single phase suspension is used as an electrode mass for preparing an electrode.

The electrode mass is applied in the form of a single phase suspension onto a conductor to produce a homogeneous coating on the coating. The electrode mass applied onto the conductor is then dried and adjusted to the desired layer thickness, such as by calendering.

The electrode thus obtained is characterized by a conductor and a homogeneous coating layer of the electrode mass applied thereon. The electrode is characterized by good physical properties and long service life when, for example, used in a high energy lithium polymer battery.

In the following, embodiments of the process according to the invention for the manufacture of electrodes are discussed in order to illustrate further aspects, advantages and effects.

### FIRST EMBODIMENT

A preferred manufacturing process for an anode is hereinafter described. The electrode material mixture for an anode may contain the following components AI-AIII, for example.

AI: Active Anode Material

The active anode material is preferably a carbon capable of intercalation with Li. Examples of such carbon materials are synthetic or natural graphite, mesocarbon microbeads, globular graphite powder (e.g., SGB series globular graphite powder from SEC Corp., Amagasaki, Hyogo, Japan), and the like. The active anode material can be used in the form of powders or fibres and can be employed in particular in a quantity of approximately 50 to 80% by weight, based on the electrode mass as a whole.

AII: Additives

The active anode material can also contain optional battery-specific additives, for example, in a quantity of 1-10% by weight, based on the electrode mass as a whole. Additives preferably used are polymers such as polyvinyl pyrrolidone; fluoroelastomers such as polyvinylidene fluoride (PVDF) and vinylidene fluoride/hexafluoropropylene copolymer (e.g., respectively, Kynar 761® and Kynar 2810® from Atofina Chemicals, Inc., Philadelphia, Pa.); Sn powder; and terpolymers composed of tetrafluoroethylene, hexafluoropropylene and vinylidene fluoride (e.g., Dyneon 220® or 340® of 3M Company, St. Paul, Minn.).

AIII: Supporting Electrolyte/Solvent

The active anode material generally comprises 5-20% by weight of supporting electrolytes and/or aprotic solvents which promote conductivity. Suitable supporting electrolytes and solvents are described in “Handbook of Battery Materials”, I. O. Besenhard, VCH Weinheim, 1999, pages 462 and 463, and chapter 7.2. In this embodiment of the process, supporting electrolytes and solvents are preferably used in micro-encapsulated form, although this does not need to be the case in other embodiments. Micro-encapsulation methods are described in “Ullmann's Industrial Chemistry” vol. A 16, VCH Weinheim, 1990, page 575, for example. The aforementioned publications are incorporated herein by reference.

Supporting electrolytes which are particularly preferred are Li organoborates such as Li oxalatoborate or LiPF₆. The supporting electrolytes are preferably used in combination with other additives such as MgO, Al₂O₃, SiO₂ or silicates.

Solvents which are particularly preferred are aprotic solvents, such as alkyl carbonates, glycol ethers or perfluoroethers.

The components AI to AIII detailed above are thoroughly mixed and then homogenized with a polymer dispersion used as a binder in order to produce the electrode mass in the form of a single phase suspension. This single phase suspension is then applied as a homogeneous coating layer onto the conductor by means of a continuous or batch-wise coating method, for example. The coating is dried and adjusted to the desired thickness, preferably by calendering. The thickness of the coating obtained is preferably 10-50 μm, more preferably 20-30 μm.

The polymer dispersion used as a binder can consist of a primary or secondary dispersion. In a primary dispersion, monomers are polymerized by emulsion polymerization, dispersion polymerization or suspension polymerization, with addition of dispersants. In a secondary dispersion, polymers are dispersed with the addition of dispersants (i.e., dispersion following polymerization). Suitable dispersion processes for this purpose are described, for example, in H. G. Elias, Makromoleküle, volume 2, page 741 (1992), Hüttig & Wepf Verlag, Basle, the entire disclosure of which is incorporated herein by reference.

Preferred binders are those based on fluoropolymers, or polyolefins based on ethylene, propylene, isobutene, butene, butadiene and/or isoprene. They may comprise homopolymers or copolymers with other unsaturated comonomers. Further binders which are preferred comprise terpolymers based on polyvinylidene fluoride (PVDF), hexafluoropropylene (HFP) and a perfluoroalkoxyether.

In contrast to prior processes, it is not just carbon black which is homogenized with a latex additive according to the present invention, but rather the entire anode material, including additives. If necessary, the supporting electrolytes are mixed and homogenized until present as a single phase suspension which is applied onto the conductor. In this way, a homogeneous layer of electrode mass is formed on the conductor. The homogeneous layer guarantees excellent electrochemical and physical properties, such as a high ultimate tensile strength and excellent electrode mass adhesion of the to the conductor.

Preferably, a Cu foil, in particular a Cu foil with a thickness of 10-20 μm, is used for the anode conductor. The conductor may comprise a variety of geometrical forms or shapes. Preferred are conductors taking the form of foils/films, strips, Möbius tapes, cylinders, beads, tubes, networks or wires, for example.

The conductor for the anode is preferably employed without a primer. However, a primer layer may be applied to the anode conductor to improve conductivity before applying the layer of electrode mass. The primer layer may comprise, in particular, graphite, carbon black, conductive carbon black, Sn powder, borate or silicate filled with carbon black, a conductive polymer, or a combination thereof. The proportion of carbon black or Sn may comprise, for example, 2540% by weight, based on the weight of the primer. Particularly preferred primer combinations are graphite and Li silicate; conductive carbon black and Li silicate; carbon black and tetrafluoroethylene/hexafluoropropylene/vinylidene fluoride terpolymer; and Sn powder and tetrafluoroethylene/hexafluoropropylene/vinylidene fluoride terpolymer. The tetrafluoroethylene/hexafluoropropylene/vinylidene fluoride terpolymer may comprise, for example, Dyneon THV 200 D® (for use with carbon black) or Dyneon THV 220 D® (for use with Sn powder). Dyneon THV 200 D® and Dyneon THV 220 D® are products of the 3M Company.

The primer can be applied by liquid or spray coating with subsequent drying. The thickness of the primer is most appropriately 1-5 μm, but other thicknesses may be utilized.

### SECOND EMBODIMENT

According to a second embodiment, a preferred process for the manufacture of a cathode is described using components KI-KIII.

KI: Active Cathode Material

A Li intercalatable metal oxide is preferably utilized as a cathode material, in the form of a powder or defined nanoparticles. In particular, oxides of heavy metals selected from the group of Mn, Ni, Co, Ti, W, Mo and Cr, and are suitable for use as cathode materials. The active cathode material can be used in a quantity of, e.g., 50 to 80% by weight, based on the electrode mass as a whole.

KII: Additives

Optional additives, for example in an amount of 1-10% by weight based on the electrode mass as a whole, may be additionally present in the cathode material. Polymers such as polyvinyl pyrrolidone, and/or copolymers, fluoroelastomers and, in particular, terpolymers thereof, are preferred additives.

KIII: Supporting Electrolyte/Solvent

The active cathode material generally comprises 5-20% by weight of supporting electrolytes and/or aprotic solvents. The particular proportions may be selected as for the active anode material (AIII, above). Supporting electrolytes for the cathode material are preferably employed in combination with additives such as MgO; Al₂O₃; SiO₂; or silicates, e.g. permutites, vermiculite or the like. As in the preparation of the anode (AIII, above), micro-encapsulation of the cathode material components is preferred, although it is possible to use non-encapsulated components, depending on the requirements.

For the cathode conductor, a primer-coated Al foil is preferably but not necessarily used, most appropriately in a thickness of 10-20 μm. To improve the conductivity of the cathode, the primer layer may comprise, for example, graphite, carbon black, conductive carbon black, Sn powder, a silicate, a conductive polymer, or a combination thereof. Appropriately, the proportion of carbon black or Sn may be 25-40% by weight, based on the weight of the primer. Particularly preferred primer combinations are graphite and Li silicate; conductive carbon black and Li silicate; carbon black and tetrafluoroethylene/hexafluoropropylene/vinylidene fluoride terpolymer; and Sn powder and tetrafluoroethylene/hexafluoropropylene/vinylidene fluoride terpolymer. The tetrafluoroethylene/hexafluoropropylene/vinylidene fluoride terpolymer may comprise, for example, Dyneon THV 200 D® (for use with carbon black) or Dyneon THV 220 D® (for use with Sn powder). The primer can be applied by liquid or spray coating with subsequent drying. Appropriately, the thickness of the primer may be 1-5 μm, but other thicknesses are possible.

The process for the manufacture of cathodes according to the invention can be carried out in a manner analogous to the process used for the anodes, by thoroughly mixing components KI to KIII and then homogenizing them following the addition of the polymer dispersion until a single phase suspension is formed.

As in the process for the manufacture of the anodes, the single phase suspension of the cathode mass can be applied onto the conductor or the primer-coated conductor, dried and subsequently adjusted to a thickness of 10-50 μm, preferably 30-40 μm, preferably by calendering.

### THIRD EMBODIMENT

In this embodiment, a high energy lithium polymer battery with an anode, cathode and a separator is described. The anode and/or cathode is made according to the processes described in Embodiments 1 and 2. However, it is also possible to use a different manufacturing process for electrodes for as long as at least one electrode mass is applied as an electrode mass layer in the form of a single phase suspension onto the conductor or the primer-coated conductor.

To separate the anode from the cathode, the battery further comprises a separator arranged between the two electrodes. The separator may consist in particular of perforated polymer film of polypropylene, or polyethylene between two polypropylene films (e.g., Celgard® of Celgard Inc. 13800 S. Lakes Drive, Charlotte, N.C.). The separator may also consist of an extruded film which may consist of expandable polymers pre-filled with electrolyte and containing inorganic fillers, if necessary. The manufacture of the separator appropriately takes place by mixing the individual components. Preferred conditions are temperatures of 25° C. to 160° C., e.g. in a Voith mixer. A particularly preferred mixture of components for the separator consists of the following components: 15% by weight of vinylidene fluoride/hexaflouropropylene copolymer (Kynar 2801®); 15% by weight of tetrafluoroethylene/hexafluoropropylene/vinylidene fluoride terpolymer (Dyneon THV 120®); 5% by weight of styrene-butadiene copolymer (Styroflex®, BASF, 3000 Continental Dr. North, Mount Olive, N.J.) and 10% by weight of MgO. Following intensive stirring, the mixture is heated at 150° C., then discharged and granulated. Modifications of the process consistent with the knowledge of persons skilled in the art are possible.

As in the Second Embodiment, the granulated mixture is then passed to an extruder and 55% by weight of a 1 molar LiPF₆ solution in ethylene carbonate/diethyl carbonate (1:1) is continuously added via a metering pump, mixed at an extruder temperature of 105° C., and discharged at a discharge temperature of 90° C. at the extruder slot die with a width of 150 mm and a thickness of 30 μm. Persons skilled in the art will be familiar with deviations and modifications of these manufacturing conditions. The separator foil/film thus obtained is wound in the case of a stepwise process (e.g. with insulating paper as an intermediate layer). In the case of a continuous process, the separator foil/film is passed directly to further processing, i.e., coating with anode or cathode mass.

However, it is also possible to use a separator without a supporting electrolyte. The separator can be produced as described above, but without the addition of the supporting electrolyte LiPF₆. Thus, the aprotic solvents (ethylene carbonate/diethyl carbonate 1:1) are merely incorporated into the polymer mixture via the metering pump in the extruder, preferably together with MgO. The quantity of aprotic solvents can be, e.g., 55% by weight (based on the separator mass as a whole). In this case, a separator film with a width of 150 mm and a thickness of 25 μm, for example, can be obtained.

The practice of the invention is illustrated by the following non-limiting examples. The parts indicated are parts by weight.

### EXAMPLE 1

### Anode Manufacture

To 80 parts of synthetic graphite in the form of mesophase carbon microbeads, (MCMB 26) and 2 parts of Sn powder (particle diameter 2 to 10 μm), are added 10 parts of Li oxalatoborate (micro-encapsulated) and 18 parts of a mixture of ethylene/propylene carbonate (1:1) (micro-encapsulated). The mixture is introduced into 300 ml of a 10% aqueous dispersion of tetrafluoroethylene/hexafluoropropylene/vinylidene fluoride terpolymer (Dyneon THV 120®) with stirring. This mixture is then homogenized at room temperature for approximately 20 minutes, e.g. by means of an Ultra-Turrax® mixer at 1500-2000 rpm until the component mixture is present as a single phase suspension. The resulting homogeneous electrode mass is then applied by means of a roller or a pasting machine onto Cu foil (12 μm, non-primer coated) and dried in a high frequency dryer. The coating layer remaining on the Cu foil has a thickness of 35-40 μm. A homogeneous coating of thickness 20-32 μm is obtained by calendering at 60-70° C.

### EXAMPLE 2

### Cathode Manufacture

85 parts of Li intercalatable Co oxide are thoroughly mixed with 2 parts of Li acetyl acetonate. Five parts of polyvinyl pyrrolidone (Luviskol K90®, BASF AG, Ludwigshafen, Germany), 10 parts of micro-encapsulated Li oxalatoborate and 20 parts of a 1:1 mixture of ethylene/propylene carbonate (also micro-encapsulated), are added, and the mixture is introduced into 300 ml of a 7% aqueous dispersion of tetrafluoroethylene/hexafluoropropylene/vinylidene fluoride terpolymer (Dyneon THV 120®) and homogenized with stirring in a dissolver for 30 minutes at 2000 rpm and room temperature. The single phase suspension thus obtained is applied with a pasting machine onto a primer-coated 8 μm thickness Al foil, dried in a high frequency drying facility, and calendered at 60-70° C. The coating on the Al foil is 40-45 μm thick.

### EXAMPLES 3 TO 6

In keeping with Examples 1 and 2, mixtures with the components listed in Table 1 are produced. The mixtures are homogenized after the addition of a polymer dispersion to form a single phase suspension.

TABLE 1

| | Example | | | |
|---|---|---|---|---|
| | 3 | 4 | 5 | 6 |
| Carbon (Li | 180 | 180 | — | — |
| intercalated) | | | | |
| Metal oxide (Li | — | — | 190 Co | 190 Co |
| intercalated) | | | oxide | oxide |
| Supporting electrolyte | 15 LiOB | 20 LiPF₆ | 20 LiOB | 20 LiOB |
| Solvent | 25 EC/PC | 30 EC/PC | 30 EC/PC | 30 DEC/PC |
| | 1:1 | 1:1 | 1:1 | 1:1 |
| Additive | 5 Sn | — | — | — |
| Polymers | 5 PVP | 2 PVP | — | — |
| Dispersion | 300 DI | 300 DI | 300 DI | 300 DII |
| | 10% | 10% | 10% | 10% |
| Layer thickness [μm] | 25-30 | 25-30 | 32-36 | 30-35 |

LiOB = Li oxalatoborate
EC = ethylene carbonate
PC = propylene carbonate
DEC = diethyl carbonate
PVP = polyvinyl pyrrolidone (Luviskol K90 ®)
DI = Dyneon THV 120 ® (fluoroelastomer, terpolymer)
DII = styrene/butadiene copolymer (styrene/butadiene, 30%/70%)
Layer thickness = following high frequency drying and calendering

If electrode production is carried out under standard conditions according to usual coating methods, polymer binders in a solvent, e.g. N-methylpyrrolidone (NMP), are added to the anode and/or cathode mass containing intercalatable carbon and/or intercalatable heavy metal oxides. The mixture is processed into a paste and coated onto a conductor foil. Subsequently, the solvent (NMP: boiling point 18-82° C., 10 mm) is removed by thermal treatment up to a residual quantity of less than 0.5% since, otherwise, the NMP interferes with the process. The remaining film contains only the active electrode masses and polymer binder, i.e., no aprotic solvent and no supporting electrolyte is contained in the electrode mass. These must be added subsequently.

If, on the other hand, the conventional extrusion coating method is used, none of the supporting electrolytes described above is again used since otherwise decomposition of the supporting electrolyte occurs. As a consequence, the supporting electrolyte must be subsequently incorporated into the electrode mass.

The electrodes produced according to the process of the invention exhibit major mechanical preferences, apart from their electrochemical advantages. The electrodes are resistant to fracture and are easy to wind, such as around a narrow mandrel (diameter 5 mm). Moreover, the electrode mass exhibits excellent adhesion to conductors. Adhesion remains intact after charging and discharging. This excellent adhesion of the homogeneous layer of electrode mass also has the effect of preventing the solvent or electrolyte from migrating beneath the mass. The adhesion also prevents the occurrence of corrosion effects or the formation of local elements. The electrodes and the batteries made from the electrodes of the invention have good storage properties and are subject to almost no fading, thus giving a high energy density of more than 120 Wh/kg.

All documents referred to herein are incorporated by reference. While the present invention has been described in connection with the preferred embodiments and the various figures, it is to be understood that other similar embodiments may be used or modifications and additions made to the described embodiments for performing the same function of the present invention without deviating therefrom. Therefore, the present invention should not be limited to any single embodiment, but rather should be construed in breadth and scope in accordance with the recitation of the appended claims. Unless specifically noted, references herein to the singular “a” also include the plural.

1. A process for the manufacture of an electrode comprising a conductor and an active electrode mass, for high energy lithium polymer batteries, the process comprising the steps of:
(i) preparing an electrode material mixture by mixing an Li intercalatable active electrode material, a supporting electrolyte and a solvent;
(ii) mixing the electrode material mixture with a binder;
(iii) homogenizing the electrode material mixture until an active electrode mass is provided as a single phase suspension;
(iv) applying the active electrode mass as a homogeneous coating onto a conductor;
(v) drying the active electrode mass applied to the conductor; and
(vi) adjusting the electrode mass to a desired layer thickness.

2. The process according to claim 1, wherein the binder is selected from the group of (i) fluoropolymers and (ii) polyolefin homopolymers and copolymers based on one or more of ethylene, propylene, isobutene, butene, butadiene or isoprene monomers, which polyolefin copolymers optionally comprise further unsaturated comonomers.

3. The process according to claim 2, wherein the binder comprises a terpolymer based on polyvinylidene fluoride, hexafluoropropylene and a perfluoroalkoxyether.

4. The process according to claim 1, wherein the binder is in the form of a polymer dispersion.

5. The process according to claim 4, wherein the polymer dispersion is a primary dispersion.

6. The process according to claim 4, wherein the polymer dispersion is a secondary dispersion.

7. The process according to claim 1, wherein the active electrode material comprises a Li intercalatable carbon, for manufacture of an anode.

8. The process according to claim 7, wherein the Li intercalatable carbon is in the form of a powder or fibres.

9. The process according to claim 1, wherein the active electrode material comprises a Li intercalatable metal oxide, for production of a cathode.

10. The process according to claim 9, wherein the active electrode material for the cathode comprises an Li intercalatable oxide of a metal selected from the group consisting of Mn, Co, Ti, W, M, and Cr.

11. The process according to claim 10, wherein the Li intercalatable metal oxide is in the form of nanoparticles.

12. The process according to claim 10, wherein the Li intercalatable metal oxide is in the form of a powder.

13. The process according to claim 1, wherein the active electrode material is present in the amount of 50 to 80% by weight, based on the total electrode mass.

14. The process according to claim 1, wherein the supporting electrolyte comprises an Li organoborate or LiPF₆.

15. The process according to claim 1, wherein the solvent is an aprotic solvent selected from the group consisting of alkyl carbonates, glycol ethers and perfluoroethers.

16. The process according to claim 15, wherein the supporting electrolyte, the aprotic solvent, or both, are micro-encapsulated.

17. The process according to claim 1, wherein the supporting electrolyte and solvent comprise 5-20% by weight of the electrode mass.

18. The process according to claim 1, wherein the electrode material mixture further comprises an additive selected from the group of Sn powder, polyvinyl pyrrolidone and fluoroelastomers, for manufacture of an anode.

19. The process according to claim 1, wherein the electrode material mixture further comprises an additive selected from the group of MgO, Al₂O₃, SiO₂ and silicates, for production of an anode.

20. The process according to claim 18, wherein the additives are in micro-encapsulated form.

21. The process according to claim 19, wherein the additives are in micro-encapsulated form.

22. The process according to claim 1, wherein the single phase suspension of the electrode mass is applied to the conductor continuously or batch-wise.

23. The process according to claim 1, wherein a primer layer is applied to the conductor before the application of the electrode mass.

24. The process according to claim 23, wherein the primer layer applied contains graphite, carbon black, conductive carbon black, Sn powder, a Li silicate, a conductive polymer, or a combination thereof.

25. The process according to claim 23, wherein the application of the primer layer is by liquid or spray coating.

26. The process according to claim 24, wherein the application of the primer layer is by liquid or spray coating.

27. The process according to claim 26, wherein the layer thickness of the electrode mass is adjusted by calendering to 10 to 50 μm.

28. The process according to claim 27, wherein the thickness of the calendered layer of the electrode mass is 20 to 30 μm.

29. The process according to claim 28, wherein the thickness of the calendered layer of the electrode mass is 30 to 40 μm.

30. An electrode produced by the process according to claim 1.

31. A process for production of a high energy lithium polymer battery comprising an anode, a cathode and separator therebetween, the process comprising:
combining a cathode and anode, at least one of which anode or cathode is an electrode according to claim 30, with a separator therebetween to form a composite system;
placing the composite system in a housing; and
poling the composite system to form a battery.

32. A process according to claim 30, wherein the composite system further comprises a conterelectrode.
